(19) United States
(12) Patent Application Publication
(10) Pub. No.: US 2023/0145183 A1
(43) Pub. Date: May 11, 2023

(54) LOAD DISTRIBUTION AND ALLOCATION OF RESOURCES IN AIRCRAFT

(71) Applicant: Airbus Defence and Space GmbH, Taufkirchen (DE)

(72) Inventor: Miriam Fleckenstein, Taufkirchen (DE)

(21) Appl. No.: 18/086,085

(22) Filed: Dec. 21, 2022

Related U.S. Application Data
(63) Continuation of application No. PCT/EP2021/061337, filed on Apr. 29, 2021.

(30) Foreign Application Priority Data
Jun. 30, 2020 (DE) 10 2020 006 834.0

(51) Int. Cl. G06F 9/50

(52) U.S. Cl. CPC G06F 9/5027

(57) ABSTRACT

A resource allocation device for an aircraft includes a user interface and a control unit. The user interface receives user inputs and generates control commands on the basis thereof. The control unit activates based on the control commands one of possible applications for a resource allocation to processes, performs one or more processes and uses during the execution of the processes a peripheral device or peripheral devices of the aircraft. One application defines which process receives which proportion of a totality of available resources of the aircraft.

### TECHNICAL FIELD

The description relates to resource management in an aircraft, in particular a military aircraft such as a combat aircraft. In particular, the description relates to a resource allocation device and an aircraft with such a resource allocation device.

### BACKGROUND

Military aircraft, especially combat aircraft, can be regarded as a system network of sensors, effectors and control devices. Combat aircraft often operate in a group consisting of two or more aircraft. However, taking into account its technical equipment and capabilities, a combat aircraft is typically designed to act as a self-sufficient system. In the present case, the concept of a self-sufficient system is understood to mean that the devices in a combat aircraft communicate and interact with each other in order to be able to perform a task. This does not preclude the combat aircraft from communicating with external facilities such as a command post or other combat aircraft.

In its capacity as a self-sufficient system, it is advantageous if the use of the systems on board, i.e. sensors, effectors and other technical and military devices, is coordinated.

### SUMMARY

It can be considered as an object to improve the allocation of resources available on board an aircraft, in particular a military combat aircraft.

This object is achieved with the subject matter disclosed herein.

According to one aspect, a resource allocation device for an aircraft is specified. The resource allocation device has a user interface and a control unit. The user interface is designed to receive user inputs and generate control commands based thereon. The control unit is designed to activate one of a plurality of possible use cases for resource allocation to processes based on the control commands. The control unit is further implemented to carry out one or more processes and to access a peripheral device or multiple peripheral devices of the aircraft when carrying out the processes, wherein a use case defines which process receives which proportion of a totality of available resources of the aircraft.

A use case is a mission schedule that defines the key data and the method of operation of the processes during a specific mission or a phase of an operation. A use case can also be referred to as a resource allocation plan. The method of operation arrived at in this way applies as long as the selected application is active. Different use cases can therefore be selected or activated for different missions or phases of an operation. Thus, a use case determines how many resources and which resources a process receives while the use case is selected or active. This makes it possible to make a pre-selection of which processes are to be carried out with which resources and under which conditions before the aircraft is deployed. These activities no longer have to be carried out individually during the operating time of the aircraft, but certain scenarios (use cases) are configured or prepared in advance so that an operator of the aircraft or pilot can retrieve and activate these use cases at operating time, whereby not only is a single process supplied with resources, but also the framework conditions for a plurality of processes are defined, and which process receives what proportion of the available resources of the aircraft is determined for as long as the use case is active.

A process can also be referred to as a task or a function and accesses peripheral devices and their functions to obtain data and to deliver a result or intermediate result based on those data and, if appropriate, following a processing step.

Often, processes in a combat aircraft access sensors that detect the environment. Under different mission or combat scenarios or operation or flight phases, different sensor modes of operation are advantageous or different sensors are operated in different ways and with different intensity (and thus with varying energy requirements). This method of operation can be part of a predefined use case. The use of such use cases can relieve the load on the pilot, because for certain scenarios only the corresponding use case has to be selected, without the pilot having to worry about the selection of sensors and the allocation of resources to individual processes.

A use case is loaded into the control unit and this use case determines how the resource allocation to a process is carried out. The processes access peripheral devices when they are implemented.

The resource allocation approach described here makes it possible to dynamically adjust the available resources during an operation or mission of the aircraft depending on external conditions. In other words, the framework conditions for the use of resources can be dynamically adapted by the corresponding processes during the operating time of the aircraft. By selecting a use case, the processes running on a flight computer can be dynamically assigned a different proportion of the resources. Thus, it is not necessary to allocate resources for the peripheral devices manually and individually. Rather, this is carried out in a bundled manner by selecting a suitable use case, wherein a use case advantageously allocates the resources of multiple peripheral devices to multiple processes.

The user interface may be designed as a human-machine interface in an aircraft, for example as a display together with input elements (for example buttons or switches or other known input elements suitable for a combat aircraft) in a cockpit of the aircraft. By the user interface, an operator can make entries and information can be displayed to that operator.

The resource allocation device may comprise a configuration interface which is designed to load use cases into the control unit before the start of an aircraft mission. The use cases can, for example, be loaded as data files into a memory of the control unit and kept there for retrieval by the operator during the operating time of the aircraft.

In the course of a mission or flight, the focus or the relevant information changes. When taking off the aircraft, for example, it is highly relevant to monitor the area in front of the aircraft to avoid collisions. In a target area of the mission, however, the tracking of a movement path of an object can be of higher relevance, because this information is decisive to fulfilling the mission.

The control unit makes it possible that, depending on the flight phase or the mission, a process receives the resources predetermined according to a use case in order to process the data relevant in the respective flight phase or mission phase with the required precision and in the required time and to provide the corresponding results.

The resource allocation device as described herein allows a dynamically variable implementation of the operational concerns and/or requirements for an aircraft as well as a variable resource allocation to the processes carried out by the control unit depending on a particular situation.

According to an embodiment, a peripheral device is an element from the group comprising the following elements: an infrared sensor, an optical camera, a radar system, a laser sensor, an active or passive sensor for electronic warfare, a communication device.

In particular, the resource allocation device as described herein assigns authorization to a process to use one of these peripheral devices with a specific priority and for a specific time.

According to another embodiment, the available resource of a peripheral device is the usage time of a peripheral device by a process.

According to a further embodiment, a process is a function from the following list of functions: searching for an object, observing an object of interest, identifying an object, controlling a guided missile launched by its own aircraft, tracking an object, mapping a terrain area with or without objects on it, exchanging data for communication purposes with a remote station.

According to a further embodiment, the control unit is designed to dynamically and optionally access one or more of the peripheral devices when carrying out a process based on a current load on the peripheral devices.

This means that for a process, depending on the load on the peripheral devices, those peripheral devices are selected that currently have free resources. For the process of observing an object, for example, the infrared sensor, the optical camera, or the radar system or a combination of these can be selected. Depending on the load on the peripheral devices, the control unit for the process can select one or more of the peripheral devices in question. This approach allows the peripheral devices to be dynamically assigned to the processes so that the resources in the aircraft are better used overall and a single bottleneck (for example, in the form of a single heavily loaded peripheral device) does not block or slow down the processing of multiple processes.

According to a further embodiment, the control unit is designed to contain a plurality of use cases, wherein each use case differs from the other use cases in that each use case allocates different proportions of the totality of available resources to the processes.

As a result, different use cases are optimized for use under different external conditions or scenarios. Because the use cases are defined before the operating time or before the start of a mission, it is possible to define a use case and the respective resource allocation without great time pressure and without the acute threat in a combat situation. This allows the use cases to be tailored to specific situations and thus to contain the resource allocation deemed optimal in advance for a particular scenario.

According to a further embodiment, the control unit is designed to activate a particular use case from the plurality of use cases based on the control commands during the operating time of the aircraft.

This allows a pilot to react dynamically to a changed situational picture during a flight. The aircraft is not rigidly bound to a predetermined mission schedule. Rather, in the event of a changed situation, a different use case can be selected, which makes a more suitable resource allocation to the processes carried out by the control unit for the current situation.

According to a further embodiment, the control unit is designed to assign a priority to the processes, wherein the control unit is further implemented to operate the processes with resources according to their priority if the totality of available resources is insufficient to operate all processes with the resources allocated to them as planned.

It is conceivable that in a use case, more resources are allocated to processes than are actually available. This is possible because not all processes are necessarily carried out continuously. Therefore, even low-priority processes can receive resources. However, if a higher priority process is being carried out, a lower priority process is suspended from being carried out.

According to another embodiment, the control unit is designed to automatically assign more resources to a process when a condition defined in the use case occurs.

This embodiment comes into play when the sensors of the aircraft detect an enemy object or a weapon aimed at the aircraft or a missile approaching. In this case, i.e. when this condition occurs, the process tracking the enemy object or the approaching missile is allocated more resources without the need for pilot intervention.

According to another aspect, the aircraft is specified with a resource allocation device as described herein. The aircraft is a military aircraft, such as a combat aircraft.

However, the resource allocation device can also be used in other vehicles in which the resource allocation of devices to processes plays a relevant role, especially in the military sector. Thus, the resource allocation device can be used in combat ships or military land vehicles.

### BRIEF DESCRIPTION OF THE DRAWINGS

Further details are described with reference to the figures. The figures are schematic and not true to scale.

FIG. 1 shows a schematic representation of a resource allocation device.

FIG. 2 shows a schematic representation of a resource allocation device.

FIG. 3 shows a schematic representation of an aircraft with a resource allocation device.

### DETAILED DESCRIPTION

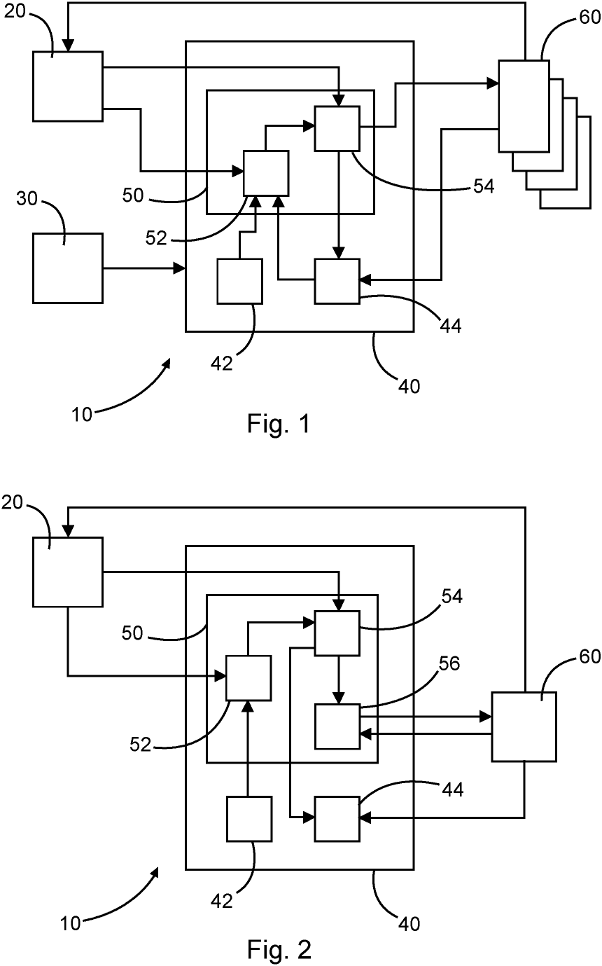

FIG. 1 shows a resource allocation device 10. The resource allocation device 10 comprises an operator interface 20, a configuration interface 30, and a control unit 40. In addition, peripheral devices 60 are provided, such as sensors of the type described above, which collect data from the environment, process the data if appropriate and pass on processed or unprocessed data in order to contribute to the fulfilment of a mission. Generally speaking, the peripheral devices 60 interact with the resource allocation device 10 or one of its components.

The control unit 40 contains a system status database 42, an object tracking database 44 and a sensor manager 50. The sensor manager 50 includes a control demand unit 52 and a request generation unit 54.

The control unit 40 may be designed as a computer/calculator or as a processor, controller, microcontroller or the like. The control unit 40 is designed to execute machine-readable commands and thereby to implement predetermined functions. The control unit 40 may also contain a memory for this purpose (not shown separately), in which the instructions to be executed are stored.

The operator interface 20 may in particular be a combination of an output element and one or more input elements. For example, the output element can be a display. The input elements can be designed as knobs, buttons, switches or the like. The operator interface 20 is used to present information to a pilot and receive input from the pilot.

The configuration interface 30 is used to supply the control unit 40 with one or more use cases. The configuration interface may be designed, for example, as a wired or wireless data transmission interface to which an external computer can be connected to transfer the data of one or more use cases to the control unit 40.

The interaction and data flow between the individual components of the resource allocation device 10 are represented by arrows and connecting lines.

Some of the blocks in FIG. 1 may be implemented as structural elements or hardware. This applies, for example, to the operator interface 20, the configuration interface 30, and the control unit 40. Other blocks shown in FIG. 1 represent, for example, memory chips, functions or function modules, which are implemented as executable machine-readable instructions from the control unit 40.

The system status database 42 and the object tracking database 44 are designed as volatile or non-volatile memory modules. The memory modules may be part of the control unit 40 or may be present separately from it. If the memory modules are separated from the control unit 40, then there is at least one data connection between the control unit 40 and the memory modules, via which data can be exchanged in at least one direction (reading, from the memory modules to the control unit), but preferably bidirectionally.

The sensor manager 50 is implemented as a function in the control unit 50 and is carried out by it. The sensor manager 50 in turn contains further functions such as the control demand unit 52 and the request generation unit 54.

Entries made by a pilot at the operator interface 20 are converted into control commands and transmitted to both the control demand unit 52 and the request generation unit 54. The control demand unit 52 contains at least the active use case which specifies the resource allocation to processes. In addition, the control demand unit 52 may contain multiple other predefined use cases. Preferably, however, only one use case is active at a time. It is also conceivable that the control demand unit 52 activates separate use cases for different system areas, but in such a case each use case may exclusively have one or more processes and one or more resources/peripheral devices available so that assignments of multiple use cases do not collide or create a conflict. The active use case is selected by the operator interface 20. The control demand unit 52 receives information from the system status database 42 and the object tracking database 44.

The system status database 42 contains information about the aircraft in which the resource allocation device 10 is arranged. This information includes condition information about the aircraft as such and about the individual systems of the aircraft, such as the operating state, the load, the measured values reported by sensors, etc., and also information about the surroundings of the aircraft.

The object tracking database 44 contains information about objects that are located outside the aircraft and may be commonly referred to as objects defining the situation or scenario. In the object tracking database 44, for example, information about the objects, their movement and other parameters (identification information, etc.) are stored.

Generally speaking, the control unit 40 carries out processes (tasks) that access peripheral devices 60, such as sensors of the type described above, receive data from the peripheral devices, and process or pass on this data to contribute to the fulfilment of a mission. The control unit 40 thus carries out computer-implemented operations which access the peripheral devices at least by reading and further process the data thus obtained.

The use case activated in the control demand unit 52 assigns resources to the processes which the control unit 40 carries out and which access the peripheral devices 60 (for example, sensors) based on the specifications of the use case and, if appropriate, with the addition of information from the system status database 42 and the object tracking database 44. The control demand unit 52 determines, based on the active use case, which process of the control unit 40 may access which sensor 60, for how long and with what power level. This allocation of resources is carried out taking into account the specifications in the use case.

The operator interface 20 also provides control commands to the request generation unit 54, which is responsible for the direct control of the peripheral devices 60 based on the specifications of the control demand unit 52. For this purpose, the request generation unit 54 may be connected to each peripheral device 60 so that control commands can be transmitted to the peripheral devices 60. The request generation unit 54 accesses information in the object tracking database 44, for example, to adjust the sensors appropriately so that an object to be tracked is appropriately detected by a sensor or group of sensors.

The peripheral devices 60 provide their output values both to the operator interface 20, where they are displayed to the pilot, and to the object tracking database 44, which stores the updated information about an object.

FIG. 2 shows a resource allocation device 10, which additionally contains a request allocation unit 56 compared to the example in FIG. 1.

The functional and structural building blocks, which have already been described with reference to FIG. 1, are not described again at this point, since their function and operation are also the same in the example of FIG. 2.

The request allocation unit 56 assigns a peripheral device 60 or sensor to a request supplied by the request generation unit 54. Thus, a further functional separation is carried out here. In the example of FIG. 2, only a resource request is generated by the request generation unit 54, but it does not directly access the resource. Access to the peripheral devices and the allocation of the peripheral devices to a process is carried out in this example by the request allocation unit 56. The request allocation unit 56 has in particular the task of load distribution between the individual peripheral devices. In the example of FIG. 2, the peripheral devices provide information about their allocation and their load to the request allocation unit 56, so that better load distribution can be carried out here comparable to a closed control loop.

The resource allocation device 10 described herein allows a functional separation between requesting a function by the pilot and selecting and assigning a resource by the resource allocation device 10. In an aircraft, using the resource allocation device 10, the pilot merely specifies which function is to be carried out, and the use case determines how the function is carried out and which resources are used for it.

The control demand unit 52 is embedded as a functional block in a flight control computer and evaluates entries from the pilot as well as sensor values about the situation of the aircraft, the environment and objects in the vicinity of the aircraft. The pilot can set the focus of the observation using the operator interface 20 and the control demand unit 52 determines, based on the use case, which sensors are controlled and how to deliver the results desired by the pilot to the accuracy and/or level of detail specified for the use case. For example, the pilot may prioritize a terrain area or an object, and the control demand unit controls the peripheral devices 60 accordingly and allocates appropriate resources to the processes carried out by the control unit 40.

The control demand unit 52 prioritizes from a plurality of processes to meet the priorities specified by the pilot, taking into account the resource allocation specified in the use case. Thus, the pilot does not directly access the processes to assign them a priority, but rather specifies which task the control demand unit 52 should primarily perform and the control demand unit 52 allocates resources to the processes according to the active use case so that the task specified by the pilot is fulfilled.

For example, more resources can be automatically assigned to a process if there is additional knowledge regarding the information that the process is processing. For example, if a process tracks an object that turns out to be an object belonging to hostile forces, the control demand unit 52 may allocate more resources to that process according to the previously defined and active use case. It is also conceivable that the pilot specifies the relevance of an object via the operator interface 20, then the process tracking this object also receives more resources, provided that the active use case allows the pilot this classification of an object.

The peripheral devices 60 may be sensors, communication devices or other functional units of an aircraft. The control demand unit 52 may, for example, be designed to access another aircraft of its own unit via a communication link and query measurement results of the sensors of the other aircraft for its own needs. This can happen, for example, if the other aircraft is in a better position to provide better reconnaissance results or if its own aircraft does not have sufficient resources or they are used to capacity.

The load distribution and the resource allocation to processes of the control unit 40 can thus be carried out not only locally on one aircraft, but also distributed to multiple aircraft.

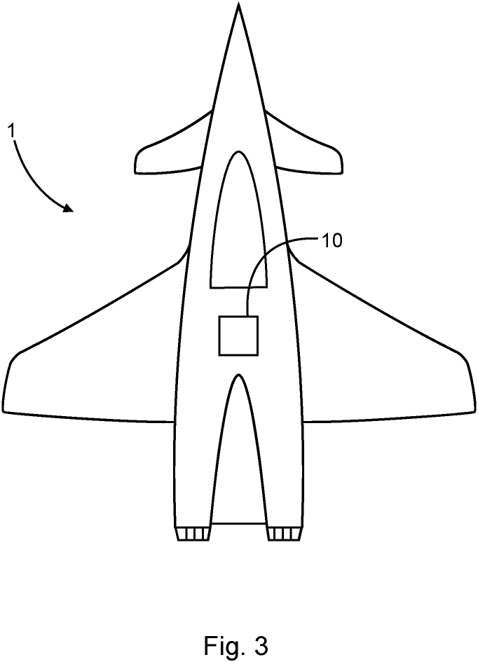

FIG. 3 shows by way of example a combat aircraft 1, which contains a resource allocation device 10 as described with reference to FIG. 1 and FIG. 2.

It should be noted that the resource allocation device 10 may also be used in other vehicles, in particular military combat vehicles.

The subject matter disclosed herein can be implemented in or with software in combination with hardware and/or firmware. For example, the subject matter described herein can be implemented in or with software executed by a processor or processing unit. In one example implementation, the subject matter described herein can be implemented using a computer readable medium having stored thereon computer executable instructions that when executed by a processor of a computer control the computer to perform steps. Example computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

List of reference characters

| | |
|---|---|
| 1 | Aircraft |
| 10 | Resource allocation device |
| 20 | Operator interface |
| 30 | Configuration interface |
| 40 | Control unit |
| 42 | System status database |
| 44 | Object tracking database |
| 50 | Sensor manager |
| 52 | Control demand unit |
| 54 | Request generating unit |
| 56 | Request allocation unit |
| 60 | Peripheral device, sensor |

1. A resource allocation device for an aircraft, the resource allocation device comprising:
a user interface configured to receive user input and generate control commands based thereon;
a control unit configured to activate based on the control commands one of a plurality of possible use cases for a resource allocation to processes;
wherein the control unit is configured to carry out one or more processes and to access a peripheral device or multiple peripheral devices of the aircraft when carrying out the processes; and
wherein a use case defines which process receives which proportion of a totality of available resources of the aircraft.

2. The resource allocation device of claim 1, wherein a peripheral device is an element from the group consisting of an infrared sensor, an optical camera, a radar system, a laser sensor, an active or passive sensor for electronic warfare, and a communication system.

3. The resource allocation device of claim 2, wherein an available resource of a peripheral device is usage time of a peripheral device by a process.

4. The resource allocation device of claim 1, wherein a process is a function selected from the group of functions consisting of searching for an object, observing an object of interest, identifying an object, controlling a guided missile, tracking an object, mapping an area of terrain with or without objects on it, and exchanging data for communication purposes with a remote station.

5. The resource allocation device of claim 1, wherein the control unit is configured to dynamically and optionally access one or more of the peripheral devices when carrying out a process based on a current load on the peripheral devices.

6. The resource allocation device of claim 1,
wherein the control unit is configured to contain a plurality of use cases; and
wherein each use case differs from other use cases in that each use case allocates different proportions of a totality of available resources to the processes.

7. The resource allocation device of claim 6, wherein the control unit is configured to activate a particular use case from the plurality of use cases based on the control commands during operating time of the aircraft.

8. The resource allocation device of claim 6,
wherein the control unit is configured to assign a priority to the processes;
wherein the control unit is configured to operate the processes with resources according to their priority if the totality of available resources is insufficient to operate all processes with the resources allocated to them as planned.

9. The resource allocation device of claim 1, wherein the control unit is configured to automatically allocate more resources to a process when a condition defined in the use case occurs.

10. An aircraft comprising a resource allocation device of claim 1, wherein the aircraft is a military aircraft.
